(19) United States
(12) Patent Application Publication
(10) Pub. No.: US 2025/0344291 A1
(43) Pub. Date: Nov. 6, 2025

(54) OVEN APPLIANCE WITH TEMPERATURE SENSOR FAULT DETECTION VIA IMAGE ANALYSIS

(71) Applicant: Haier US Appliance Solutions, Inc., Wilmington, DE (US)

(72) Inventors: Jihwan Kim, Seoul (KR); Hyeonsoo Moon, Seoul (KR)

(21) Appl. No.: 18/653,476

(22) Filed: May 2, 2024

(51) Int. Cl. H05B 1/02; A23L 5/10; A47J 36/32; F24C 7/08

(52) U.S. Cl. CPC H05B 1/0263; A23L 5/15; A47J 36/321; F24C 7/085; F24C 7/087

(57) ABSTRACT

An oven appliance includes a heating element, a temperature sensor, and a camera provided in a cooking chamber defined by the oven appliance. A method of controlling the oven appliance includes initiating a cooking operation of the oven appliance, capturing a first image of a food item inside the cooking chamber using the camera, and determining one or more characteristics of the food item from the first image. The method also includes measuring a first temperature of the food item, estimating an expected temperature of the food item in response to the one or more determined characteristic, and comparing the first temperature of the food item to the expected temperature of the food item. The method further includes ending the cooking operation in response to the first temperature of the food item deviating from the expected temperature of the food item by a threshold amount.

### FIELD OF THE INVENTION

The present subject matter relates generally to oven appliances, and more particularly to temperature sensor fault detection in oven appliances using image analysis.

### BACKGROUND OF THE INVENTION

Oven appliances generally include a cabinet that defines a cooking chamber for cooking food items therein, such as by baking or broiling the food items. In order to perform the cooking operation, oven appliances typically include one or more heating elements, or heating elements, provided in various locations within the cooking chamber. These heating elements may be used together or individually to perform various specific cooking operations, such as baking, broiling, roasting, and the like.

In general, oven appliances may include a temperature sensor positioned within the cooking chamber. However, current oven appliances may not be able to determine if the temperature sensor in the cooking chamber is faulty. Accordingly, when cooking operations occur with a faulty temperature sensor, the cooking operations may lead to undercooked or overcooked foods, depending on what is being cooked and the state at which it is placed in the cooking chamber.

Accordingly, an oven appliance and a method of operating the oven appliance that may determine if the temperature sensor in the cooking chamber is faulty would be beneficial. Particularly, an oven appliance and method of operating an oven appliance that is able to intelligently determine food types, doneness, and determine a temperature would be desirable.

### BRIEF DESCRIPTION OF THE INVENTION

Aspects and advantages of the invention will be set forth in part in the following description, or may be obvious from the description, or may be learned through practice of the invention.

In one example embodiment of the present disclosure, a method of operating an oven appliance is provided. The oven appliance includes a heating element, a temperature sensor, and a camera provided in a cooking chamber defined by the oven appliance. The method includes initiating a cooking operation of the oven appliance, capturing a first image of a food item inside the cooking chamber using the camera, and determining one or more characteristics of the food item from the first image. The method also includes measuring a first temperature of the food item, estimating an expected temperature of the food item in response to the one or more determined characteristic, and comparing the first temperature of the food item to the expected temperature of the food item. The method further includes ending the cooking operation in response to the first temperature of the food item deviating from the expected temperature of the food item by a threshold amount.

In another example embodiment of the present disclosure, a cooking appliance is provided. The cooking appliance includes a cabinet defining a cooking chamber and a heating element disposed in the cooking chamber. The heating element is configured to provide heat to the cooking chamber. The cooking appliance also includes a camera disposed in the cooking chamber, a temperature sensor disposed in the cooking chamber, and a controller in operable communication with the heating element and the camera. The controller is configured to initiate a cooking operation of the oven appliance, capture a first image of a food item inside the cooking chamber using the camera, and determine one or more characteristics of the food item from the first image. The controller is also configured to measure a first temperature of the food item, estimate an expected temperature of the food item in response to the one or more determined characteristic, and compare the first temperature of the food item to the expected temperature of the food item. The controller is further configured to end the cooking operation in response to the first temperature of the food item deviating from the expected temperature of the food item by a threshold amount.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an example oven appliance with the door in a closed position according to example embodiments of the present disclosure.

FIG. 2 provides a front view of an interior of a cooking chamber of an example oven appliance according to example embodiments of the present disclosure.

FIG. 3 provides a flow chart illustrating a method of operating an oven appliance according to example embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. In the context of an angle or direction, such terms include values within ten degrees greater or less than the stated direction. For example, “generally vertical” includes directions within ten degrees of vertical in any direction, e.g., clockwise or counter-clockwise.

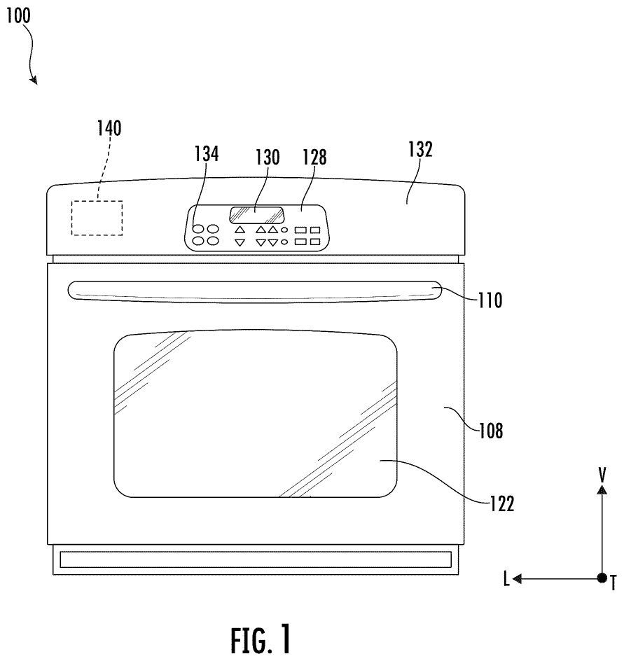

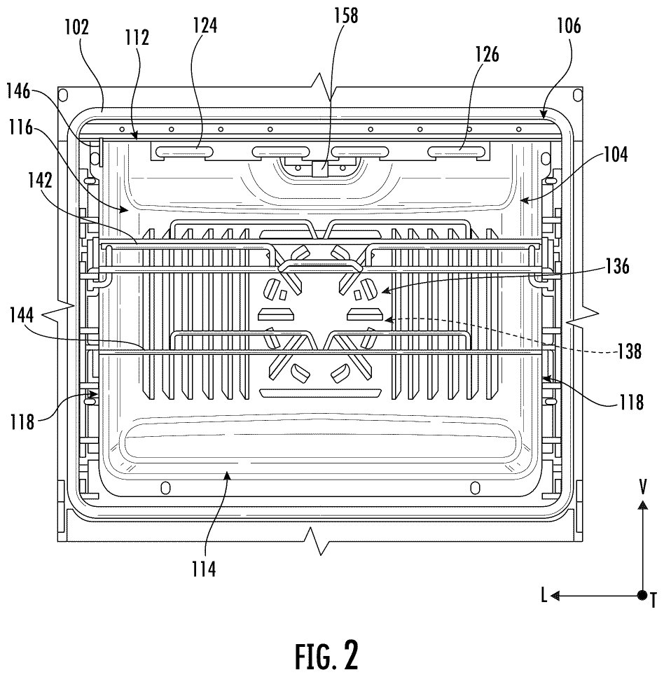

Referring to FIGS. 1 and 2, for this example embodiment, oven appliance 100 may include an insulated cabinet 102 with an interior cooking chamber 104 defined by a top wall 112, a bottom wall 114, a back wall 116, and a pair of opposing side walls 118. Cooking chamber 104 is configured for the receipt of one or more food items to be cooked. Oven appliance 100 includes a door 108 pivotally mounted, e.g., with one or more hinges (not shown), to cabinet 102 at the opening 106 of cabinet 102 to permit selective access to cooking chamber 104 through opening 106. A handle 110 may be mounted to door 108 to assist a user with opening and closing door 108. For example, a user can pull on handle 110 to open or close door 108 and access cooking chamber 104.

Oven appliance 100 may include a seal (not shown) between door 108 and cabinet 102 that assists with maintaining heat and cooking vapors within cooking chamber 104 when door 108 is closed as shown in FIGS. 1 and 2. Multiple parallel glass panes 122 provide for viewing the contents of cooking chamber 104 when door 108 is closed and assist with insulating cooking chamber 104. A baking rack may be positioned in cooking chamber 104 for the receipt of food items or utensils containing food items. For example, the cooking chamber may include a first baking rack 142 and a second baking rack 144. Each of first baking rack 142 and second baking rack may be conveniently moved into and out of cooking chamber 104 when door 108 is open (i.e., via rails provided on each of side walls 118). First baking rack 142 may be arranged above second baking rack 144 (e.g., in the vertical direction V). Thus, first baking rack 142 may be closer to top wall 112 of cabinet 102 than second baking rack 144.

One or more heating elements may be provided at the top, bottom, or both of cooking chamber 104, and may provide heat to cooking chamber 104 for cooking. Such heating element(s) can be gas, electric, microwave, or a combination thereof. For example, in the embodiment shown in FIG. 2, oven appliance 100 includes a first top heating element 124 and a second top heating element 126, where second top heating element 126 is positioned adjacent to first top heating element 124. Other configurations with or without a wall may be used as well. For instance, a bottom heating element may be incorporated in addition or alternatively to the first and second top heating elements 124 and 126.

Oven appliance 100 may also have a convection heating element 136 and convection fan 138 positioned adjacent back wall 116 of cooking chamber 104. Convection fan 138 may be powered by a convection fan motor. Further, convection fan 138 may be a variable speed fan—meaning the speed of fan 138 may be controlled or set anywhere between and including, e.g., zero and one hundred percent (0%-100%). In certain embodiments, oven appliance 100 also includes a bidirectional triode thyristor (not shown), i.e., a triode for alternating current (TRIAC), to regulate the operation of convection fan 138 such that the speed of fan 138 may be adjusted during operation of oven appliance 100. The speed of convection fan 138 may be determined by controller 140. In addition, a sensor such as, e.g., a rotary encoder, a Hall effect sensor, or the like, may be included at the base of fan 138 to sense the speed of fan 138. The speed of fan 138 may be measured in, e.g., revolutions per minute (“RPM”). In some embodiments, the convection fan 138 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cooking chamber. As another example, in some embodiments reversing the direction results in air being directed from the top and/or sides of the cooking chamber rather than the back of the cooking chamber.

In various embodiments, more than one convection heater, e.g., more than one convection heating elements 136 and/or convection fans 138, may be provided. In such embodiments, the number of convection fans and convection heaters may be the same or may differ, e.g., more than one convection heating element 136 may be associated with a single convection fan 138. Similarly, top heating elements and/or bottom heating elements may be provided in various combinations, e.g., one top heating element with two or more bottom heating elements, two or more top heating elements 124, 126 with no bottom heating element, etc.

Oven appliance 100 may include a user interface 128 having a display 130 positioned on an interface panel 132 and having a variety of user input devices, e.g., controls 134. Interface 128 may allow the user to select various options for the operation of oven 100 including, e.g., various cooking and cleaning cycles. Operation of oven appliance 100 may be regulated by a controller 140 that is operatively coupled, i.e., in communication with, user interface 128, heating elements 124, 126, 136 and other components of oven 100 as will be further described.

For example, in response to user manipulation of the user interface 128, controller 140 may operate the heating element(s). Controller 140 may receive measurements from one or more temperature sensors such as temperature sensor 146 described below. Controller 140 may also provide information such as a status indicator, e.g., a temperature indication, to the user with display 130. Controller 140 may also be provided with other features as will be further described herein.

Controller 140 may include a memory and one or more processing devices such as microprocessors, CPUs, or the like, such as general or special purpose microprocessors operable to execute programming instructions or micro-control code associated with operation of oven appliance 100. The memory may represent random access memory such as DRAM or read only memory such as ROM or FLASH. In one embodiment, the processor executes programming instructions stored in memory. The memory may be a separate component from the processor or may be included onboard within the processor. The memory may store information accessible by the processor(s), including instructions that can be executed by processor(s). For example, the instructions can be software or any set of instructions that when executed by the processor(s), cause the processor(s) to perform operations. For the embodiment depicted, the instructions may include a software package configured to operate the system to, e.g., execute the example methods described below. Controller 140 may also be or include the capabilities of either a proportional (P), proportional-integral (PI), or proportional-integral-derivative (PID) control for feedback-based control implemented with, e.g., temperature feedback from one or more sensors, such as temperature sensor 146.

Controller 140 may be positioned in a variety of locations throughout oven appliance 100. In the illustrated embodiment, controller 140 is located next to user interface 128 within interface panel 132. In other embodiments, controller 140 may be located under or next to the user interface 128 otherwise within interface panel 132 or at any other appropriate location with respect to oven appliance 100. In the embodiment illustrated in FIG. 1, input/output (“I/O”) signals are routed between controller 140 and various operational components of oven appliance 100 such as heating elements 124, 126, 136, convection fan 138, controls 134, display 130, alarms, and/or other components as may be provided. In one embodiment, user interface 128 may represent a general purpose I/O (“GPIO”) device or functional block.

In the illustrated embodiments, the user input device is provided as touch type controls 134, however, it should be understood that controls 134 and the configuration of oven appliance 100 shown in FIG. 1 are illustrated by way of example only. For example, the user interface 128 may be provided as a touchscreen which provides both the display 130 and the controls 134. As further examples, the user interface 128 may include various input components, such as one or more of a variety of electrical, mechanical, or electro-mechanical input devices including rotary dials, push buttons, and touch pads. User interface 128 may include other display components, such as a digital or analog display device designed to provide operational feedback to a user. In some embodiments, user interface 128 may be in communication with controller 140 via one or more signal lines or shared communication busses. In other embodiments, the user interface 128 may be configured as an external computing device or remote user interface device, such as a smart phone, tablet, or other device capable of connecting to the controller 140. For example, the remote user interface device may be a handheld user interface with a display thereon, e.g., a touchscreen display. The remote user device may connect to the controller 140 wirelessly using any suitable wireless connection, such as wireless radio, WI-FI®, BLUETOOTH®, ZIGBEE®, laser, infrared, and any other suitable device or interface. For example, in some embodiments, the remote user interface may be an application or “app” executed by a remote user interface device such as a smart phone or tablet. Signals generated in controller 140 may operate appliance 100 in response to user input via the user interface 128.

While oven 100 is shown as a wall oven, the present invention could also be used with other cooking appliances such as, e.g., a stand-alone oven, an oven with a stove-top, or other configurations of such ovens. Numerous variations in the oven configuration are possible within the scope of the present subject matter. For example, variations in the type and/or layout of the controls 134, as mentioned above, are possible. As another example, the oven appliance 100 may include multiple doors 108 instead of or in addition to the single door 108 illustrated. Such examples include a dual cavity oven, a French door oven, and others. The examples described herein are provided by way of illustration only and without limitation.

A camera 158 may be provided within cooking chamber 104. Generally, camera 158 may be a video camera or a digital camera with an electronic image sensor [e.g., a charge coupled device (CCD) or a CMOS sensor]. When assembled, camera 158 is in communication (e.g., electric, or wireless communication) with controller 140 such that controller 140 may receive a signal from camera 158 corresponding to images captured by camera 158. Camera 158 may be configured to capture images of cooking chamber 104 (e.g., an interior of cabinet 102), and controller 140 may conduct “image analysis” of the images as will be explained further hereinbelow. Camera 158 may be located in any suitable location within cooking chamber 104, such that first baking rack 142 and second baking rack 144 are visible to camera 158. For example, as shown in FIG. 2, camera 158 may be located at or near top wall 112 of cooking chamber 104 in the vertical direction V (e.g., between the first and second heating elements 124, 126 along the lateral direction L). Additionally or alternatively, camera 158 may be located at or near a center of cooking chamber 104 in the lateral direction L. The specific location of camera 158 is not limited, however, and one of ordinary skill in the art would appreciate multiple potential locations for camera 158.

According to example embodiments of the present subject matter, method 300, as will be explained hereinbelow, may include obtaining one or more images of food item(s). Although the term “image” is used herein, it should be appreciated that according to example embodiments, camera 158 may take any suitable number or sequence of two-dimensional images, videos, or other visual representations of the food item(s). For example, the one or more images may include a video feed or series of sequential static images obtained by camera 158 that may be transmitted to the controller 140 (e.g., as a data signal) for analysis or other manipulation. These obtained images may vary in number, frequency, angle, field-of-view, resolution, detail, etc.

In general, method 300 may include analyzing the one or more images to identify characteristics of the food items. According to example embodiments, this image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor the food item(s). It should be appreciated that this image analysis or processing may be performed locally (e.g., by controller 140) or remotely (e.g., by offloading image data to a remote server or network).

Specifically, the analysis of the one or more images may include implementation of an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object, the existence of a certain condition, etc. For example, one or more reference images may be obtained when a particular condition exists, and these references images may be stored for future comparison with images obtained during appliance operation. Similarities and/or differences between the reference image and the obtained image may be used to extract useful information for improving appliance performance.

According to example embodiments, image processing may include blur detection algorithms that are generally intended to compute, measure, or otherwise determine the amount of blur in an image. For example, these blur detection algorithms may rely on focus measure operators, the Fast Fourier Transform along with examination of the frequency distributions, determining the variance of a Laplacian operator, or any other methods of blur detection known by those having ordinary skill in the art. In addition, or alternatively, the image processing algorithms may use other suitable techniques for recognizing or identifying items or objects, such as edge matching or detection, divide-and-conquer searching, greyscale matching, histograms of receptive field responses, or another suitable routine (e.g., executed at the controller 140 based on one or more captured images from one or more cameras). Other image processing techniques are possible and within the scope of the present subject matter. The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the example image analysis or evaluation processes described below may be used independently, collectively, or interchangeably to extract detailed information regarding the images being analyzed to facilitate performance of one or more methods described herein or to otherwise improve appliance operation. According to example embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an example embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the covn5 property map instead of the initially split into zone recommendations. In addition, according to example embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to example embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models. According to example embodiments, it should be appreciated that the machine learning models may include supervised and/or unsupervised models and methods. In this regard, for example, supervised machine learning methods (e.g., such as targeted machine learning) may help identify problems, anomalies, or other occurrences which have been identified and trained into the model. By contrast, unsupervised machine learning methods may be used to detect clusters of potential failures, similarities among data, event patterns, abnormal concentrations of a phenomenon, etc.

It should be appreciated that image processing and machine learning image recognition processes may be used together to facilitate improved image analysis, object detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only example and are not intended to limit the scope of the present subject matter in any manner.

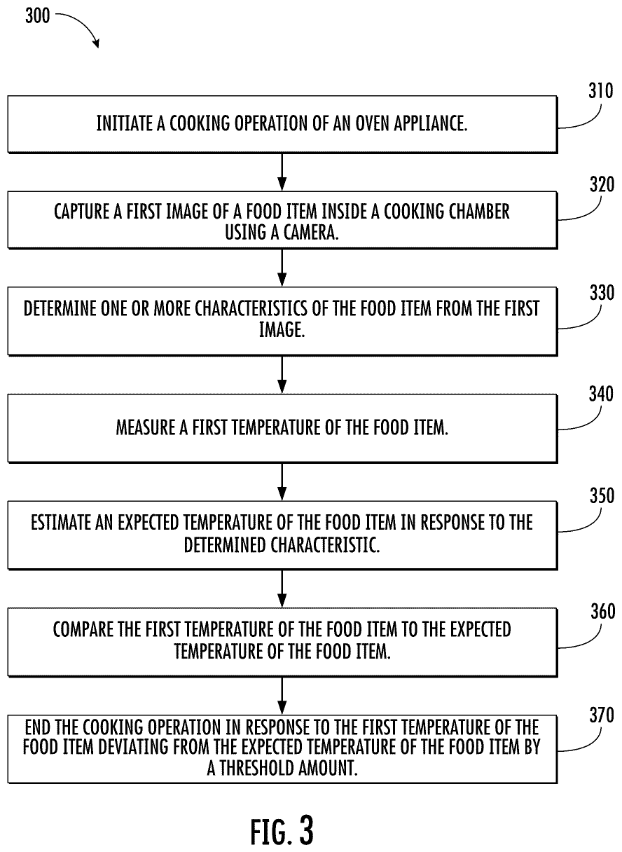

Furthermore, it should be noted that controller 140 may be capable of and may be operable to perform any methods, method steps, or portions of methods as disclosed hereinbelow. For example, in some embodiments, methods disclosed hereinbelow may be embodied in programming instructions stored in the memory and executed by controller 140. Specifically, referring now to FIG. 3, a flow diagram of one embodiment of a method 300 of operating oven appliance 100 is illustrated in accordance with aspects of the present subject matter. In general, method 300 will be described herein with reference to the embodiments of oven appliance 100 above with reference to FIGS. 1 and 2. However, it should be appreciated by those of ordinary skill in the art that the disclosed method 300 may generally be utilized in association with apparatuses and systems having any other suitable configuration, such as an oven appliance with multiple cooking chambers, a stand-alone oven, an oven with a stove-top, or other configurations of such ovens. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 3, at (310), method 300 may generally include initiating a cooking operation of the oven appliance. Generally, a user may begin a cooking operation by placing one or more food items in a cooking chamber of an oven appliance (e.g., cooking chamber 104 of oven appliance 100) and selecting a desired cooking mode and/or a specified temperature level of the oven appliance. For example, a user may choose to bake (e.g., selecting a bake mode) a food item at three hundred and seventy-five degrees Fahrenheit (375° F.). At which point, the cooking operation may begin by activating heating element(s) in order to bring the temperature inside cooking chamber 104 to three hundred and seventy-five degrees Fahrenheit (375° F.).

At (320), method 300 may generally include capturing a first image of the cooking chamber using the camera, or, more specifically, capturing a first image of the food item inside the cooking chamber, such as with camera 158. In general, within the cooking chamber and the line of sight of the camera, one or more food items may be positioned. Thus, a camera (e.g., camera 158) within the cooking chamber may capture a first image of the food item or items placed in the cooking chamber. The camera may then transmit the captured first image or images to a controller, such as controller 140.

At (330), method 300 may generally include determining one or more characteristics of the food item(s) from the first image. In general, the controller may determine a type of food in each zone. For instance, the controller may analyze the image of the food item and extract one or more characteristics relating to the food item (e.g., color, size, doneness, moisture content, etc.). Using the extracted characteristic(s), the controller may reference a programmed formula, chart, or table. As an example, the controller may consult a lookup table stored within the oven appliance to determine what type of food is provided based on a comparison with the extracted characteristic(s) of the food item. For instance, a qualitative attribute of a particular characteristic may be assigned a quantitative value within the lookup table (e.g., a level of brownness from 0 to 10). Additionally or alternatively, the camera may detect various optical characteristics, such as wavelength bands, infrared emittance, and the like. Using the extracted characteristic(s), the controller may reference a programmed formula, chart, or table. As an example, the controller may consult the lookup table stored within the oven appliance to determine what type of food is provided based on a comparison with the extracted characteristic(s). For instance, a qualitative attribute of a particular characteristic may be assigned a quantitative value within the lookup table (e.g., a level of brownness from 0 to 10, a food volume estimation, etc.).

At (340), method 300 may generally include measuring a first temperature of the food item. In general, temperature sensor 146 may be a probe style resistance temperature detector (RTD), thermocouple, or thermistor. For instance, temperature sensor 146 may be in direct thermal communication with the food item, e.g., temperature sensor 146 may be inserted into the food item, such that temperature sensor 146 may provide the temperature of the food item at any instance during the cooking operation. For example, the food item may be measured by temperature sensor 146 to be at a temperature of seventy degrees Fahrenheit (70° F.). In general, measuring the first temperature of the food item may also include measuring the first temperature of the food item at the same time as the first image is captured. Accordingly, the first temperature may be recorded along with the first image, such that a direct comparison may be made, as will be explained further hereinbelow.

In some example embodiments, method 300 may include capturing a second image of the food item(s). For instance, the second image may be captured after a predetermined amount of time has elapsed in the cooking operation. For example, after the cooking operation has transpired for a predetermined amount of time, the camera may capture a second image of the cooking chamber (e.g., cooking chamber 104). In particular, the predetermined time or frequency may be set by a user or may be preset during manufacturing. For example, the predetermined frequency/time may be twenty minutes (20 min) or less, such as ten minutes (10 min) or less, such as five minutes (5 min) or less, etc. Additionally or alternatively, the camera may capture a plurality of sequential images at the predetermined frequency. In general, each image captured by the camera may be transmitted to the controller.

Moreover, method 300 may include determining updates for the one or more characteristics relating to the food item (e.g., color, size, doneness, moisture content, etc.) from the second image. In particular, updates for the one or more characteristics may include determining new qualitative attributes of the particular characteristic, which may be assigned a new quantitative value. In some example embodiments, the one or more characteristics of the food item from the first image may be compared to the second image. For instance, method 300 may include comparing a change in the one or more characteristics of the food item from the first image to the second image. Specifically, the controller may compare the food item in the first image to the food item in the second image. For example, method 300 may compare a change in color of the food item between the first image and the second image and determines the assigned quantitative value to the determined qualitative attribute. The method may consult stored data pertaining to the particular food item (i.e., the type of food determined at 330) and analyze a cooking progress based on the change in the one or more characteristics.

In the case of a plurality of sequential images being captured by the camera, e.g., where the first image is one image of the plurality of images, the controller may perform an analysis of two sequential images (e.g., between a first image and a second image, between the second image and a third image, or each sequential pair). For example, the controller may compare a characteristic (e.g., brownness) from the first image to the same characteristic from the second image. The controller may differentiate the qualitative assessment between the characteristic in the two images and determine the quantitative value. According to each analysis, the controller may monitor a cooking progress for the food item. Advantageously, a more accurate cooking time and cooking doneness may be obtained.

At (350), method 300 may generally include estimating an expected temperature of the food item in response to the determined characteristic. For example, the assigned/determined quantitative value (e.g., a level of brownness from 0 to 10) based upon the qualitative attribute of a particular characteristic, may correlate with an expected temperature of the food item within the lookup table. For example, when a particular example food item has a brownness level of four (4), the lookup table may indicate that the food item should be at the expected temperature of one hundred degrees Fahrenheit (100° F.).

At (360), method 300 may generally include comparing the first temperature of the food item to the expected temperature of the food item. In particular, the controller may directly compare the first temperature of the food item to the expected temperature of the food item, e.g., because the first image and the first temperature were recorded at the same time) to determine if the temperature sensor is measuring the temperature within a threshold accuracy, i.e., a threshold amount. For example, the threshold amount may be plus/minus twenty degrees Fahrenheit (20° F.), such as plus/minus ten degrees Fahrenheit (10° F.), such as plus/minus five degrees Fahrenheit (5° F.). In the previously presented examples above, the first temperature of the food item was measure to be seventy degrees Fahrenheit (70° F.), and the expected temperature of the food item was estimated to be one hundred degrees Fahrenheit (100° F.). The deviation between the first temperature to the expected temperature is calculated to be thirty degrees Fahrenheit (30° F.), which, in the present example scenario, exceeds the threshold amount.

In embodiments where the second image is taken, method 300 may generally include measuring a second temperature of the food item. Similarly to the above, method 300 may generally include estimating an expected second temperature of the food item in response to the determined updated one or more characteristics from the second image, as well as comparing the second temperature of the food item to the expected second temperature of the food item.

In some example embodiments, method 300 may further include providing a user notification in response to the comparison of the first temperature of the food item to the expected temperature of the food item. For example, in a scenario where the deviation between the first (or second) temperature and the expected temperature exceeds the threshold amount, the controller may notify a user via a user notification that the temperature sensor is faulty.

At (370), method 300 may generally include ending the cooking operation in response to the first temperature of the food item deviating from the expected temperature of the food item by over the threshold amount. In other words, the controller may deactivate the heating element(s) and stop the cooking operation, because the temperature sensor may be faulty. In general, ending the cooking operation may advantageously reduce undesired cooking results, such as overcooking of the food item, because the temperature sensor may be faulty.

As may be seen from the above, a method of diagnosing a temperature sensor (in a cooking appliance) using image analysis is provided. While starting a cooking operation, a user places the food to be cooked inside the cooking appliance (oven) along with a temperature probe or RTD temperature sensor inserted into the food. During the cooking process, the image analysis may continuously calculate the expected temperature of the food by recognizing the level of doneness based on the current status of the food (images taken by the camera). The RTD temperature sensor or the probe temperature sensor may measures the inside temperature of the food. The calculated temperature may deviate higher or lower than the measured temperature, and the system may compare the deviation to a threshold amount. Thus, the method may determine that there may be a fault in the temperature probe or RTD temperature sensor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an oven appliance, the oven appliance comprising a heating element, a temperature sensor, and a camera provided in a cooking chamber defined by the oven appliance, the method comprising:
initiating a cooking operation of the oven appliance;
capturing a first image of a food item inside the cooking chamber using the camera;
determining one or more characteristics of the food item from the first image;
measuring a first temperature of the food item;
estimating an expected temperature of the food item in response to the determined one or more characteristics;
comparing the first temperature of the food item to the expected temperature of the food item; and
ending the cooking operation in response to the first temperature of the food item deviating from the expected temperature of the food item by a threshold amount.

2. The method of claim 1, further comprising:
capturing a plurality of sequential images at a predetermined frequency, the first image being one image of the plurality of sequential images;
determining the one or more characteristics of the food item from each image of the plurality of sequential images; and
comparing the determined one or more characteristics of the food item between a sequential pair of the plurality of sequential images.

3. The method of claim 1, further comprising providing a user notification in response to comparing the first temperature of the food item to the expected temperature of the food item.

4. The method of claim 1, further comprising:
capturing a second image of the food item inside the cooking chamber using the camera;
measuring a second temperature of the food item;
determining updates for the one or more characteristics of the food item from the second image;
estimating an expected second temperature of the food item in response to the determined updates for the one or more characteristics; and
comparing the second temperature of the food item to the second expected temperature of the food item.

5. The method of claim 4, wherein capturing the first image of the food item and the second image of the food item occurs at a specified frequency.

6. The method of claim 1, wherein determining one or more characteristics of the food item from the first image comprises determining a quantitative value of the one or more characteristics of the food item.

7. The method of claim 6, wherein estimating an expected temperature of the food item in response to the determined characteristic comprises comparing the determined quantitative value to a lookup table of values.

8. The method of claim 1, wherein initiating a cooking operation of the oven appliance comprises activating the heating element of the oven appliance to a specified temperature.

9. The method of claim 1, wherein measuring a first temperature of the food item comprises the temperature sensor measuring the first temperature of the food item at a same time as the first image is captured.

10. The method of claim 1, wherein the one or more characteristics of the food item comprises a temperature, a color, a size, a doneness, and a moisture content.

11. A cooking appliance, comprising:
a cabinet defining a cooking chamber;
a heating element disposed in the cooking chamber and configured to provide heat to the cooking chamber;
a camera disposed in the cooking chamber;
a temperature sensor disposed in the cooking chamber; and
a controller in operable communication with the heating element and the camera, the controller configured to:
initiate a cooking operation of the cooking appliance;
capture a first image of a food item inside the cooking chamber using the camera;
determine one or more characteristics of the food item from the first image;
measure a first temperature of the food item;
estimate an expected temperature of the food item in response to the one or more determined characteristic;
compare the first temperature of the food item to the expected temperature of the food item; and
end the cooking operation in response to the first temperature of the food item deviating from the expected temperature of the food item by a threshold amount.

12. The cooking appliance of claim 11, wherein the controller is further configured to:
capture a plurality of sequential images at a predetermined frequency, the first image being one image of the plurality of sequential images;
determine the one or more characteristics of the food item from each image of the plurality of sequential images; and
compare the determined one or more characteristics of the food item between a sequential pair of the plurality of sequential images.

13. The cooking appliance of claim 11, wherein the controller is further configured to provide a user notification in response to comparing the first temperature of the food item to the expected temperature of the food item.

14. The cooking appliance of claim 11, wherein the controller is further configured to:
capture a second image of the food item inside the cooking chamber using the camera;
measure a second temperature of the food item;
determine updates for the one or more characteristics of the food item from the second image;
estimate an expected second temperature of the food item in response to the determined updated one or more characteristics; and
compare the second temperature of the food item to the expected second temperature of the food item.

15. The cooking appliance of claim 14, wherein capturing the first image of the food item and the second image of the food item occurs at a specified frequency.

16. The cooking appliance of claim 11, wherein determining one or more characteristics of the food item from the first image comprises determining a quantitative value of the one or more characteristics of the food item.

17. The cooking appliance of claim 16, wherein estimating an expected temperature of the food item in response to the determined characteristic comprises comparing the determined quantitative value to a lookup table of values.

18. The cooking appliance of claim 11, wherein initiating a cooking operation of the cooking appliance comprises activating the heating element of the cooking appliance to a specified temperature.

19. The cooking appliance of claim 11, wherein measuring a first temperature of the food item comprises the temperature sensor measuring the first temperature of the food item at a same time as the first image is captured.

20. The cooking appliance of claim 11, wherein the one or more characteristics of the food item comprises a temperature, a color, a size, a doneness, and a moisture content.
